(19) United States
(12) Patent Application Publication
(10) Pub. No.: US 2024/0373125 A1
(43) Pub. Date: Nov. 7, 2024

(54) INFORMATION PROCESSING DEVICE, INFORMATION PROCESSING SYSTEM, AND INFORMATION PROCESSING METHOD

(71) Applicant: Panasonic Intellectual Property Management Co,. Ltd., Osaka (JP)

(72) Inventors: Shunsuke YASUGI, Osaka (JP); Satoshi Sato, Kyoto (JP); Kunio Nobori, Osaka (JP)

(21) Appl. No.: 18/771,035

(22) Filed: Jul. 12, 2024

Related U.S. Application Data
(63) Continuation of application No. PCT/JP2022/048504, filed on Dec. 28, 2022.

(30) Foreign Application Priority Data
Jan. 21, 2022 (JP) 2022-007846

(51) Int. Cl. H04N 23/60; G06F 21/84; G06V 40/16; H04N 23/611; H04N 23/95

(52) U.S. Cl. CPC H04N 23/64; G06F 21/84; H04N 23/611; H04N 23/95; G06V 40/16

(57) ABSTRACT

An image capturing terminal includes an image acquisition part that acquires an image obtained through image capturing by an image capturing part, a concealment degree calculation part that calculates a concealment degree of the image, a concealment degree determination part that determines whether the concealment degree is equal to or less than a threshold value, and an output part that outputs alert information to notify that the concealment degree is declining when the concealment degree is equal to or less than a threshold value.

### FIELD OF INVENTION

The present disclosure relates to a technology to collect images with confidentiality.

### BACKGROUND ART

For example, Patent Literature 1 discloses a video monitoring system that acquires motion detection information from an input image, detects an image capturing blur by comparing edge intensity between a reference image and an input image, calculates the similarity between the reference image and the input image, detects a camera abnormality from the motion detection information, the image capturing blur, and the similarity, and displays the abnormality on a monitor or issues a warning.

However, the above conventional technology discloses issuing a warning when the image capturing blur appears in the input image but does not disclose issuing a warning if the image capturing blur no longer appears in the input image.
Patent Literature 1: JP 4626632 B2

### SUMMARY OF THE INVENTION

The present disclosure has been made to solve the above problems, and an object of the present disclosure is to provide a technology that can protect the privacy of a subject when the concealment degree of the image obtained through image capturing by an image capturing device declines.

An information processing device according to the present disclosure includes: an acquisition part that acquires an image obtained through image capturing by an image capturing device; a concealment degree calculation part that calculates a concealment degree of the image; and an output part that outputs alert information to notify that the concealment degree is declining when the concealment degree is equal to or less than a threshold value.

The present disclosure enables protection of the privacy of a subject when the concealment degree of the image obtained through image capturing by the image capturing device declines.

### BRIEF DESCRIPTION OF THE DRAWINGS

FIG. 1 is a block diagram showing one example of a configuration of an image capturing system in a first embodiment of the present disclosure.

FIG. 2 is a diagram schematically showing a structure of a multi pinhole camera as one example of an image capturing part.

FIG. 3 is a schematic diagram showing one example of a multi pinhole mask with a plurality of pinholes formed.

FIG. 4 is a flowchart for describing the image capturing process in an image capturing terminal according to the first embodiment of the present disclosure.

FIG. 5 is a block diagram showing one example of a configuration of an image capturing system in a second embodiment of the present disclosure.

### DETAILED DESCRIPTION

### (Knowledge Underlying Present Disclosure)

Various recognition technologies are important in home, indoor, or the like, such as behavior recognition of a person and person recognition of an apparatus operator. In recent years, a technology called deep learning has attracted attention for object recognition. The deep learning is machine learning using a neural network having a multilayer structure, and by using a large amount of training data, the deep learning enables more accurate recognition performance to be achieved than by a conventional method. In such object recognition, image information is particularly effective. Various techniques have been proposed for greatly improving a conventional object recognition capability by using a camera as an input device and performing deep learning using image information as an input.

However, disposing a camera in home or the like causes a problem that the privacy is violated when a captured image leaks to the outside due to hacking or the like. Therefore, a countermeasure is required to protect the privacy of a subject even if a captured image leaks to the outside.

In addition, although a camera is disposed also outdoors or in a store for the purpose of collecting big data or the like, from the viewpoint of protecting privacy, it is not preferable to collect images in which a face or the like that enables identification of an individual appears.

Therefore, images with confidentiality, that is, blurred images in which it is difficult for a person to visually recognize the subject are collected.

For example, there is a multi pinhole camera as a camera that obtains a blurred image in which it is difficult for a person to visually recognize a subject. The multi pinhole camera intentionally creates a blurred image by superimposing a plurality of images having different viewpoints.

When the multi pinhole camera has a plurality of pinholes, a plurality of subject images is superimposed, and an image in which it is difficult for a person to visually recognize the subject is obtained. Meanwhile, if some of the plurality of pinholes becomes blocked due to mischief or the attachment of dirt, there is a risk that the number of superimposed subject images will be reduced, resulting in an image in which a person can visually recognize the subject.

In this way, there is a risk that the concealment degree of the image obtained by the multi pinhole camera may decline if the number of pinholes decreases, and there is a risk that the privacy of the subject will not be able to be adequately protected.

To solve the above problems, the following technology is disclosed.

(1) An information processing device according to one aspect of the present disclosure includes: an acquisition part that acquires an image obtained through image capturing by an image capturing device; a concealment degree calculation part that calculates a concealment degree of the image; and an output part that outputs alert information to notify that the concealment degree is declining when the concealment degree is equal to or less than a threshold value.

With this configuration, when the concealment degree of the image obtained through image capturing by the image capturing device has declined, the alert information to notify that the concealment degree is declining is output, thereby protecting the privacy of the subject.

(2) In the information processing device according to (1) described above, the image capturing device may obtain a blurred image by an optical action.

With this configuration, for example, even if a blurred image cannot be obtained due to a malfunction of an optical system and the concealment degree of the image has declined, the alert information to notify that the concealment degree is declining is output, thereby protecting the privacy of the subject.

(3) In the information processing device according to (2) described above, the image capturing device may include an image capturing element and a mask having a plurality of pinholes arranged to cover a light receiving surface of the image capturing element.

With this configuration, since subject images passing through the plurality of pinholes are superimposed, the blurred image in which the subject is not recognizable can be obtained.

(4) In the information processing device according to (3) described above, the concealment degree calculation part may calculate a number of valid pinholes among the plurality of pinholes based on the image, and when the number of valid pinholes is equal to or less than a threshold value, the output part may output the alert information.

With this configuration, the number of valid pinholes among the plurality of pinholes is calculated, and when the number of valid pinholes is equal to or less than a threshold value, the alert information is output. Therefore, even if the blurred image cannot be obtained because some of the plurality of pinholes are blocked and the concealment degree of the image has declined, the alert information to notify that the concealment degree is declining is output, thereby protecting the privacy of the subject.

(5) In the information processing device according to any one of (1) to (3) described above, the concealment degree calculation part may calculate a frequency characteristic of a predetermined area in the image, and the output part may output the alert information when power of a specific frequency out of the frequency characteristic is higher than a threshold value, when a maximum value of power in a specific frequency area out of the frequency characteristic is higher than a threshold value, when a minimum value of average power in the specific frequency area out of the frequency characteristic is higher than a threshold value, or when a calculated value obtained by inputting a value of the specific frequency area out of the frequency characteristic into a specific function is higher than a threshold value.

With this configuration, a difference appears in the specific frequency out of the frequency characteristic of the predetermined area in the image between the image with confidentiality and the image with no confidentiality. Therefore, it is possible to determine whether the concealment degree is equal to or less than a threshold value by using the frequency characteristic of the predetermined area in the image.

(6) In the information processing device according to any one of (1) to (3) described above, the concealment degree calculation part may recognize a face of a subject included in the image and calculate reliability of the facial recognition, and the output part may output the alert information when the reliability of the facial recognition is higher than a threshold value.

With this configuration, when the concealment degree of the image declines, the reliability of the facial recognition increases. Therefore, it is possible to determine whether the concealment degree is equal to or less than a threshold value by using the reliability of the facial recognition.

(7) The information processing device according to any one of (1) to (6) described above may further include an image capturing control part that outputs an image capturing stop signal to stop the image capturing to the image capturing device when the concealment degree is equal to or less than a threshold value.

With this configuration, when the concealment degree of the image obtained through image capturing by the image capturing device has declined, the image capturing by the image capturing device is stopped, thereby protecting the privacy of the subject more securely.

(8) The information processing device according to any one of (1) to (7) described above may further include a communication part that transmits the alert information output from the output part to an external device connected via a network.

With this configuration, it is possible to notify the manager of the image capturing device that the concealment degree of the image obtained through image capturing by the image capturing device is declining. The notified manager can repair the image capturing device.

(9) The information processing device according to any one of (1) to (8) described above may further include a notification part that, upon acquisition of the alert information output from the output part, notifies a person who is a subject of the image capturing device that the concealment degree is declining.

With this configuration, it is possible to notify the person who is a subject of the image capturing device that the concealment degree of the image is declining. The notified person can protect the privacy of the person by leaving the image capturing range of the image capturing device.

(10) In the information processing device according to any one of (1) to (8) described above, the output part may output the alert information to a notification device, and upon acquisition of the alert information, the notification device may notify a person who is a subject of the image capturing device that the concealment degree is declining.

With this configuration, it is possible to notify the person who is a subject of the image capturing device that the concealment degree of the image is declining. The notified person can protect the privacy of the person by leaving the image capturing range of the image capturing device.

(11) The information processing device according to any one of (1) to (10) described above may further include: an image storage part that stores the image; and an image deletion part that deletes the image stored in the image storage part when the concealment degree is equal to or less than a threshold value.

With this configuration, since the image stored in the image storage part is deleted when the concealment degree is equal to or less than a threshold value, it is possible to prevent the image with lower concealment degree from being collected.

(12) The information processing device according to any one of (1) to (10) described above may further include a communication part that transmits the image to an external device connected via a network to store the image, the communication part transmitting a deletion instruction signal to delete the image stored in the external device to the external device when the concealment degree is equal to or less than a threshold value.

With this configuration, when the concealment degree is equal to or less than a threshold value, the deletion instruction signal to delete the image stored in the external device is transmitted to the external device and the image stored in the external device is deleted, making it possible to prevent the image with lower concealment degree from being collected.

(13) An information processing system according to another aspect of the present disclosure includes: an image capturing device; and the information processing device according to any one of (1) to (12) described above.

With this configuration, when the concealment degree of the image obtained through image capturing by the image capturing device has declined, the alert information to notify that the concealment degree is declining is output, thereby protecting the privacy of the subject.

The present disclosure can be implemented not only as an information processing device having the characteristic configuration as described above but also as an information processing method for executing characteristic processing corresponding to the characteristic configuration included in the information processing device. Therefore, another aspect below can also produce the effect as in the above information processing device.

(14) An information processing method according to another aspect of the present disclosure includes, by a computer: acquiring an image obtained through image capturing by an image capturing device; calculating a concealment degree of the image; and outputting alert information to notify that the concealment degree is declining when the concealment degree is equal to or less than a threshold value.

Embodiments of the present disclosure will be described below with reference to the accompanying drawings. Note that the embodiments below are one example embodying the present disclosure, and are not intended to limit the technical scope of the present disclosure.

### First Embodiment

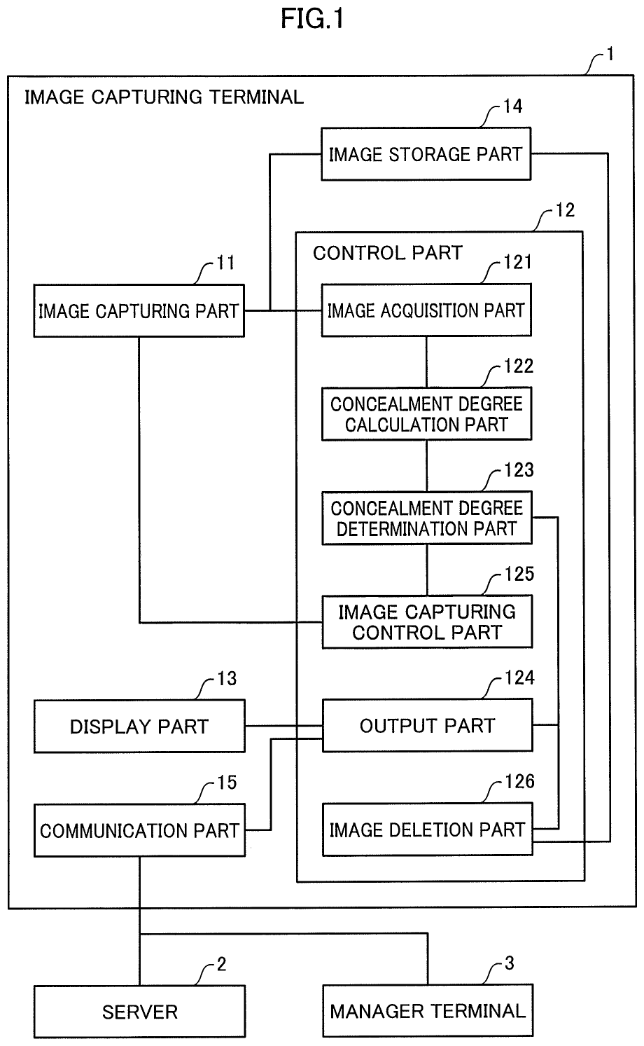

FIG. 1 is a block diagram showing one example of a configuration of an image capturing system in a first embodiment of the present disclosure. The image capturing system includes an image capturing terminal 1, a server 2, and a manager terminal 3.

The image capturing terminal 1 is installed in a house, store, or facility. The image capturing terminal 1 acquires and stores an image with the privacy or personal information protected, that is, an image with confidentiality. The image capturing terminal 1 includes an image capturing part 11, a control part 12, a display part 13, an image storage part 14, and a communication part 15.

The image capturing part 11 captures a blurred image by optical actions. The image capturing part 11 is one example of the image capturing device. The image capturing part 11 includes an optical system that modulates the point spread function. The image capturing part 11 gives confidentiality to the subject image before entering an image sensor. The image capturing part 11 does not give confidentiality by performing signal processing on the captured image output from the image sensor. The image obtained by the image capturing part 11 is an image in which due to intentionally created blur, a person cannot recognize the subject even when the person sees the image itself. The image capturing part 11 outputs the image obtained through image capturing to the image storage part 14 and the control part 12.

The image capturing part 11 is, for example, a multi pinhole camera in which a mask having a mask pattern with a plurality of pinholes formed is disposed to cover a light receiving surface of the image sensor (image capturing element). In other words, it can be said that the mask pattern is disposed between the subject and the light receiving surface.

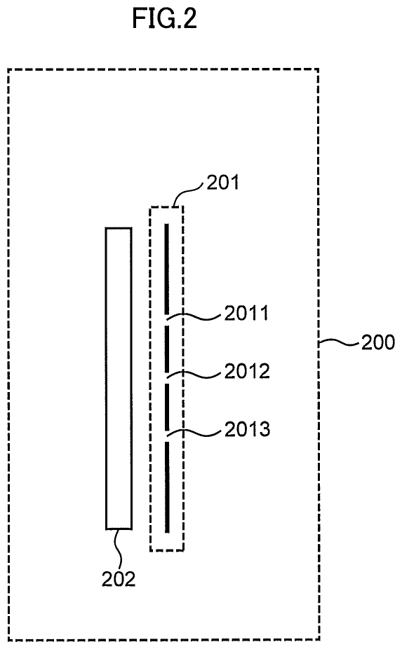

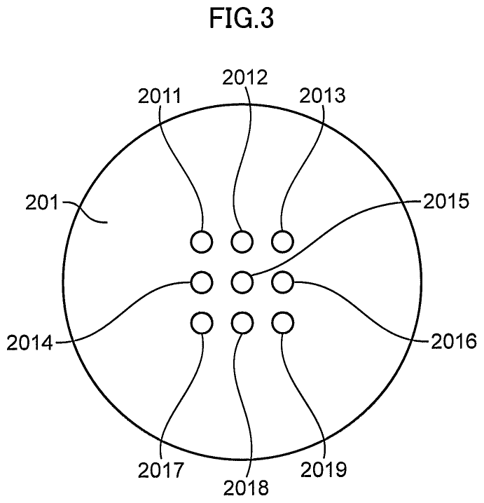

FIG. 2 is a diagram schematically showing a structure of a multi pinhole camera 200 as one example of the image capturing part 11. FIG. 3 is a schematic diagram showing one example of a multi pinhole mask 201 with the plurality of pinholes formed. Note that FIG. 2 is a top view of the multi pinhole camera 200.

The multi pinhole camera 200 shown in FIG. 2 includes the multi pinhole mask 201 and an image sensor 202 such as a CMOS. The multi pinhole camera 200 does not have a lens. The multi pinhole mask 201 is disposed a certain distance away from the light receiving surface of the image sensor 202. The multi pinhole mask 201 has nine equally spaced pinholes 2011 to 2019. The nine pinholes 2011 to 2019 are formed in a 3×3 matrix in the multi pinhole mask 201. The nine pinholes 2011 to 2019 are also referred to as multi pinholes. The image sensor 202 acquires images of a subject through respective pinholes 2011 to 2019. The images acquired through the pinholes are also referred to as pinhole images.

The pinhole images of the subject differ depending on the position and size of respective pinholes 2011 to 2019. Therefore, the image sensor 202 acquires a superimposed image where the plurality of pinhole images slightly shifts and overlaps each other (multiple image). The positional relationship of the plurality of pinholes 2011 to 2019 affects the positional relationship of the plurality of pinhole images projected onto the image sensor 202 (that is, degree of superimposition of the multiple image). The size of the pinholes 2011 to 2019 affects the degree of blur of the pinhole images.

Using the multi pinhole mask 201 enables acquiring the plurality of superimposed pinhole images each having a different position and degree of blur. That is, it is possible to acquire a computationally captured image in which the multiple image and blur are intentionally created. Therefore, the captured image is a multiple and blurred image, whose blur enables acquisition of an image with confidentiality in which the privacy of the subject is protected.

In addition, by changing the number of pinholes, the position of the pinholes, and the size of the pinholes, images with different degree of blur can be acquired. That is, the multi pinhole mask 201 may be configured to be easily detachable by a user. A plurality of types of the multi pinhole mask 201 having different mask patterns may be prepared in advance. The multi pinhole mask 201 may be arbitrarily replaced by the user depending on the mask pattern of the multi pinhole camera used during image recognition.

Note that such a change of the multi pinhole mask 201 can be achieved by the following various methods other than the replacement of the multi pinhole mask 201. For example, the multi pinhole mask 201 may be pivotably attached in front of the image sensor 202, and may be arbitrarily rotated by the user. For example, the multi pinhole mask 201 may be created by the user making a hole in an arbitrary place of a plate attached in from of the image sensor 202. For example, the multi pinhole mask 201 may be a liquid crystal mask using a spatial light modulator or the like. A predetermined number of pinholes may be formed at predetermined positions by arbitrarily setting the transmittance of positions in the multi pinhole mask 201. Furthermore, for example, the multi pinhole mask 201 may be formed by using a stretchable material such as rubber. The user may physically deform the multi pinhole mask 201 to change the position and the size of the pinholes by applying external force.

Note that in FIG. 3, the nine pinholes 2011 to 2019 are arranged in a matrix, but the present disclosure is not limited to this example. The number of pinholes is not limited to nine, and the multi pinhole mask 201 may have a plurality of pinholes, such as ten or more or eight or less. The plurality of pinholes may be arranged randomly rather than at equal intervals.

The image capturing part 11 may be, for example, other computational image capturing camera such as a lensless camera, a coded aperture camera, or a light field camera. The coded aperture camera includes a mask having a mask pattern with different transmittance in different areas.

The image capturing part 11 may be, for example, a camera with a focal position shifted from the light receiving surface of the image sensor. In this case, the image capturing part 11 includes an image sensor and a lens disposed such that the focal position exists forward or rearward of the light receiving surface of the image sensor. The focal position of the lens is not on the light receiving surface of the image sensor. Note that the focal position is determined according to the detection range from the light receiving surface to the subject to be detected. For example, when the detection range from the light receiving surface to the subject to be detected is 1 m to 10 m, the lens position is adjusted such that the focal position of the subject that is in the detection range of 1 m to 10 m from the light receiving surface is not on the light receiving surface.

Note that for a camera having a lens other than the multi pinhole camera, the concealment degree of the image declines due to lens misalignment or deterioration of the lens material. The image storage part 14 is implemented by a memory. The memory is, for example, a storage device that can store various types of information, such as a random access memory (RAM), a hard disk drive (HDD), a solid state drive (SSD), or a flash memory. The image storage part 14 stores images obtained through image capturing by the image capturing part 11.

The control part 12 is implemented by a microprocessor. The control part 12 includes an image acquisition part 121, a concealment degree calculation part 122, a concealment degree determination part 123, an output part 124, an image capturing control part 125, and an image deletion part 126.

The image acquisition part 121 acquires an image obtained through image capturing by the image capturing part 11.

The concealment degree calculation part 122 calculates the concealment degree of the image acquired by the image acquisition part 121. The concealment degree calculation part 122 calculates the number of valid pinholes among the plurality of pinholes based on the image acquired by the image acquisition part 121. The concealment degree calculation part 122 calculates the frequency characteristic of the image by signal processing and calculates the number of valid pinholes from the calculated frequency characteristic. The memory (not shown) may include a frequency characteristic storage part that stores in advance the number of pinholes and the frequency characteristic of the image captured by the multi pinhole camera having the number of pinholes in association with each other. The concealment degree calculation part 122 calculates the number of corresponding valid pinholes by matching the calculated frequency characteristic of the image with the frequency characteristic stored in the frequency characteristic storage part.

The concealment degree calculation part 122 may calculate the number of valid pinholes by inputting the captured images into an estimation model created by machine learning using a multiplexed image captured by the multi pinhole camera as input and the number of valid pinholes as output.

The concealment degree determination part 123 determines whether the concealment degree calculated by the concealment degree calculation part 122 is equal to or less than a threshold value. The concealment degree determination part 123 determines whether the number of valid pinholes calculated by the concealment degree calculation part 122 is equal to or less than a threshold value. Note that the threshold value depends on the number, position, and size of the pinholes in the multi pinhole mask 201. The concealment degree determination part 123 may make a determination every frame, may make a determination every multiple frames, or may make a determination at predetermined time intervals.

When the number of pinholes on the multi pinhole mask 201 decreases, the concealment degree (degree of confidentiality or degree of blur) of the image also declines. That is, the number of valid pinholes affects the concealment degree of the image. Therefore, the concealment degree determination part 123 can determine whether the concealment degree is equal to or less than a threshold value by determining whether the number of valid pinholes is equal to or less than a threshold value.

When the concealment degree is equal to or less than a threshold value, the output part 124 outputs alert information for notifying that the concealment degree is declining to the display part 13 and the communication part 15. That is, when the concealment degree determination part 123 determines that the concealment degree is equal to or less than a threshold value, the output part 124 outputs the alert information to the display part 13 and the communication part 15. When the number of valid pinholes is equal to or less than a threshold value, the output part 124 outputs the alert information to the display part 13 and the communication part 15.

As described above, the multi pinhole camera 200 can acquire the blurred image with confidentiality in which the privacy of the subject is protected by superimposing a plurality of subject images obtained through the plurality of pinholes. Meanwhile, if some of the plurality of pinholes becomes blocked due to mischief or the attachment of dirt, there is a risk that the number of superimposed subject images will be reduced, resulting in an image in which a person can visually recognize the subject.

In this way, there is a risk that the concealment degree of the image obtained by the multi pinhole camera 200 may decline depending on the number of pinholes, and there is a risk that the privacy of the subject cannot be adequately protected. Therefore, in the present first embodiment, the number of valid pinholes among the plurality of pinholes is calculated, and when the number of valid pinholes is equal to or less than a threshold value, the alert information is output.

When the concealment degree is equal to or less than a threshold value, the image capturing control part 125 outputs an image capturing stop signal for stopping the image capturing to the image capturing part 11. Upon acquisition of the image capturing stop signal from the image capturing control part 125, the image capturing part 11 stops the image capturing. When the image capturing is stopped, the image will no longer be output from the image capturing part 11 to the image storage part 14, and the image will no longer be stored in the image storage part 14.

The image deletion part 126 deletes the image stored in the image storage part 14 when the concealment degree is equal to or less than a threshold value. At this time, the image deletion part 126 deletes images stored in the image storage part 14 from the present time until a predetermined time before.

Note that if the concealment degree determination part 123 makes a determination every frame, the image deletion part 126 may delete only the image whose concealment degree is determined to be equal to or less than a threshold value. Meanwhile, if the concealment degree determination part 123 makes a determination every multiple frames, the image deletion part 126 may delete images multiple frames before the image at the time when the concealment degree is determined to be equal to or less than a threshold value. Meanwhile, if the concealment degree determination part 123 makes a determination at predetermined time intervals, the image deletion part 126 may delete images stored until a predetermined time before the time when the concealment degree is determined to be equal to or less than a threshold value. Furthermore, even if the concealment degree determination part 123 makes a determination every frame, the image deletion part 126 may delete images multiple frames before the image at the time when the concealment degree is determined to be equal to or less than a threshold value.

The display part 13 is, for example, a light emitting diode (LED) or a liquid crystal display device. The display part 13 is one example of a notification part. Upon acquisition of the alert information output from the output part 124, the display part 13 notifies the person who is the subject of the image capturing part 11 that the concealment degree is declining. For example, upon acquisition of the alert information, the display part 13 changes the LED light color from blue to red. When an image with confidentiality (image with blur) is captured, the LED light color is blue, whereas when an image without confidentiality (image without blur) is captured, LED light color is red. By checking the LED light color, the person who is the subject of the image capturing part 11 can confirm whether the image with confidentiality is captured by the image capturing part 11.

The communication part 15 transmits the alert information output from the output part 124 to the server 2 and the manager terminal 3 connected via a network. The server 2 and the manager terminal 3 are one example of an external device. The network is, for example, the Internet.

The server 2 is a server owned by a manufacturer that manufactures or sells the image capturing terminal 1. For example, the manufacturer centrally manages a plurality of image capturing terminals. The server 2 receives the alert information transmitted by the image capturing terminal 1. Upon receipt of the alert information, the server 2 notifies maintenance staff of the manufacturer that the concealment degree of the image captured by the image capturing terminal 1 is declining. At this time, the server 2 transmits information indicating that the concealment degree of the image captured by the image capturing terminal 1 is declining to a terminal of the maintenance staff. The terminal of the maintenance staff displays the information indicating that the concealment degree of the image captured by the image capturing terminal 1 is declining. When the information indicating that the concealment degree of the image captured by the image capturing terminal 1 is declining is displayed on the terminal, the maintenance staff performs maintenance on the image capturing terminal 1.

The manager terminal 3 is a terminal owned by a manager who manages the image capturing terminal 1. The manager terminal 3 receives the alert information transmitted by the image capturing terminal 1. Upon receipt of the alert information, the manager terminal 3 notifies the manager that the concealment degree of the image captured by the image capturing terminal 1 is declining. At this time, the manager terminal 3 displays the information indicating that the concealment degree of the image captured by the image capturing terminal 1 is declining. When the information indicating that the concealment degree of the image captured by the image capturing terminal 1 is declining is displayed on the manager terminal 3, the manager performs maintenance on the image capturing terminal 1.

Subsequently, the image capturing process in the image capturing terminal 1 according to the first embodiment of the present disclosure will be described.

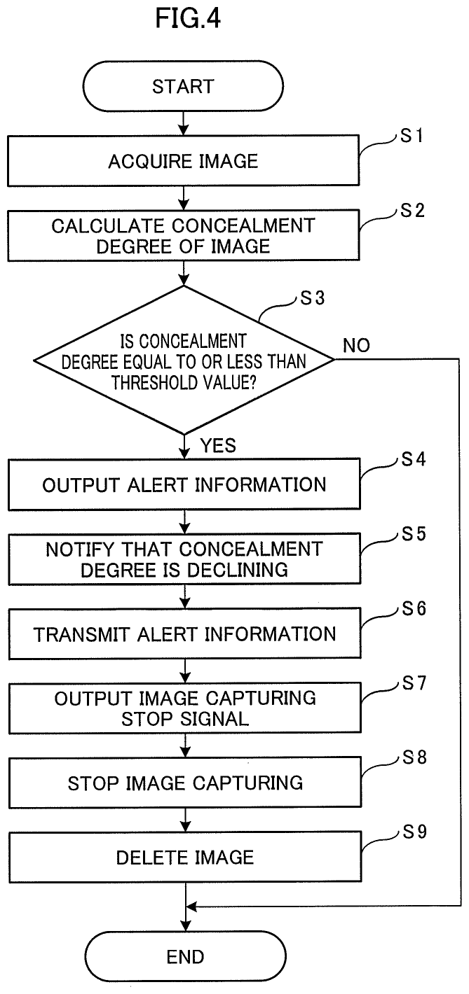

FIG. 4 is a flowchart for describing the image capturing process in the image capturing terminal 1 according to the first embodiment of the present disclosure.

First, in step S1, the image acquisition part 121 acquires an image obtained through image capturing by the image capturing part 11.

Next, in step S2, the concealment degree calculation part 122 calculates the concealment degree of the image acquired by the image acquisition part 121. At this time, the concealment degree calculation part 122 calculates the number of valid pinholes among the plurality of pinholes based on the image acquired by the image acquisition part 121.

Next, in step S3, the concealment degree determination part 123 determines whether the concealment degree calculated by the concealment degree calculation part 122 is equal to or less than a threshold value. At this time, the concealment degree determination part 123 determines whether the number of valid pinholes calculated by the concealment degree calculation part 122 is equal to or less than a threshold value.

Here, when it is determined that the concealment degree is not equal to or less than a threshold value, that is, when it is determined that the number of valid pinholes is not equal to or less than a threshold value (NO in step S3), the process ends.

On the other hand, when it is determined that the concealment degree is equal to or less than a threshold value, that is, when it is determined that the number of valid pinholes is equal to or less than a threshold value (YES in step S3), in step S4, the output part 124 outputs alert information for notifying that the concealment degree is declining to the display part 13 and the communication part 15.

Next, in step S5, the display part 13 notifies the person who is the subject of the image capturing part 11 that the concealment degree is declining by changing the LED light color from blue to red.

Note that in the present first embodiment, the display part 13 changes the LED light color from blue to red, but the present disclosure is not limited to this example. When the display part 13 is a liquid crystal display device, the display part 13 may display an image to notify that the concealment degree is declining. The display part 13 may display an image encouraging the user to leave the place. The display part 13 may notify the concealment degree converted into numbers. For example, the display part 13 may display the text “100% confidential” when nine pinholes are all valid, and may display the text “56% confidential” when five of nine pinholes are valid.

In addition, the image capturing terminal 1 may include a voice output part instead of the display part 13. The output part 124 may output the alert information to notify that the concealment degree is declining to the voice output part. The voice output part may output a voice or warning sound to notify that the concealment degree is declining.

Next, in step S6, the communication part 15 transmits the alert information output from the output part 124 to the server 2 and the manager terminal 3 connected via a network.

Next, in step S7, the image capturing control part 125 outputs the image capturing stop signal to stop the image capturing to the image capturing part 11.

Next, in step S8, the image capturing part 11 stops the image capturing.

Next, in step S9, the image deletion part 126 deletes the image stored in the image storage part 14.

In this way, when the concealment degree of the image obtained through image capturing by the image capturing part 11 has declined, the alert information to notify that the concealment degree is declining is output, thereby protecting the privacy of the subject.

Note that, as described above, the positional relationship of the plurality of pinholes affects the positional relationship of the plurality of pinhole images projected onto the image sensor. That is, there is a risk that, if the distance between two adjacent pinholes increases, the degree of superimposition between the two pinhole images will decrease, and the subject will become recognizable. Therefore, the concealment degree calculation part 122 may calculate the number of valid pinholes among the plurality of pinholes based on the image acquired by the image acquisition part 121, and may calculate the distance between two adjacent valid pinholes among the plurality of pinholes. Then, the concealment degree determination part 123 may determine whether the number of valid pinholes calculated by the concealment degree calculation part 122 is equal to or less than a threshold value, and when it is determined that the number of valid pinholes is not equal to or less than a threshold value, the concealment degree determination part 123 may determine whether the distance between two adjacent valid pinholes among the plurality of pinholes is equal to or greater than a threshold value. When the distance between the two adjacent valid pinholes among the plurality of pinholes is equal to or greater than a threshold value, the output part 124 may output the alert information.

Note that in the present first embodiment, the concealment degree calculation part 122 calculates the number of valid pinholes among the plurality of pinholes based on the image acquired by the image acquisition part 121, but the present disclosure is not particularly limited to this example. The concealment degree calculation part 122 may calculate the frequency characteristic of a predetermined area in the image acquired by the image acquisition part 121. The predetermined area is, for example, a facial area of the person who is the subject, the entire image, or a specific area on the image that includes the subject to be detected. In this case, out of the frequency characteristic of the predetermined area calculated by the concealment degree calculation part 122, the concealment degree determination part 123 may determine whether the power of a specific frequency is higher than a threshold value. When the power of the specific frequency out of the frequency characteristic of the predetermined area is higher than a threshold value, the output part 124 may output the alert information. Based on the difference between the frequency characteristic of the image with confidentiality and the frequency characteristic of the image with no confidentiality, the threshold value at the specific frequency of the frequency characteristic of the image with no confidentiality is calculated and stored in advance.

Out of the frequency characteristic of the predetermined area calculated by the concealment degree calculation part 122, the concealment degree determination part 123 may determine whether the maximum value of the power in the specific frequency area is higher than a threshold value. When the maximum value of the power in the specific frequency area out of the frequency characteristic of the predetermined area is higher than a threshold value, the output part 124 may output the alert information.

Out of the frequency characteristic of the predetermined area calculated by the concealment degree calculation part 122, the concealment degree determination part 123 may determine whether the minimum value of the average power in the specific frequency area is higher than a threshold value. When the minimum value of the average power in the specific frequency area out of the frequency characteristic of the predetermined area is higher than a threshold value, the output part 124 may output the alert information.

Out of the frequency characteristic of the predetermined area calculated by the concealment degree calculation part 122, the concealment degree determination part 123 may determine whether a calculated value obtained by inputting the value of the specific frequency area into a specific function is higher than a threshold value. The specific function is, for example, a weighted sum. Out of the frequency characteristic of the predetermined area, when the calculated value obtained by inputting the value of the specific frequency area into the specific function is higher than a threshold value, the output part 124 may output the alert information.

The concealment degree determination part 123 may input the value of the specific frequency area out of the frequency characteristic of the predetermined area calculated by the concealment degree calculation part 122 into the estimation model generated by machine learning by using the value of the specific frequency area out of the frequency characteristic of the predetermined area as input and the concealment degree as output, and acquire the concealment degree output from the estimation model. Then, the concealment degree determination part 123 may determine whether the concealment degree output from the estimation model is higher than a threshold value. When the concealment degree output from the estimation model is higher than a threshold value, the output part 124 may output the alert information.

The concealment degree determination part 123 may input the value of the specific frequency area out of the frequency characteristic of the predetermined area calculated by the concealment degree calculation part 122 into the estimation model generated by machine learning by using the value of the specific frequency area out of the frequency characteristic of the predetermined area as input and a discrimination result indicating whether to output the alert information as output, and acquire the discrimination result output from the estimation model. Then, when the discrimination result indicating that the alert information is to be output is acquired from the estimation model, the output part 124 may output the alert information.

Changes appear in the specific frequency in the frequency characteristic of the image with confidentiality (image with high concealment degree) and the frequency characteristic of the image with no confidentiality (image with low concealment degree). When the concealment degree of the image (degree of confidentiality or degree of blur) declines, out of the frequency characteristic of the predetermined area in the image, the power of the specific frequency increases. That is, the frequency characteristic of the predetermined area in the image affects the concealment degree of the image. Therefore, the concealment degree determination part 123 can determine whether the concealment degree is equal to or less than a threshold value by determining whether the power of the specific frequency out of the frequency characteristic of the predetermined area in the image is higher than a threshold value, whether the maximum value of the power in the specific frequency area out of the frequency characteristic of the predetermined area in the image is higher than a threshold value, whether the minimum value of the average power in the specific frequency area out of the frequency characteristic of the predetermined area in the image is higher than a threshold value, or whether the calculated value obtained by inputting the value of the specific frequency area out of the frequency characteristic of the predetermined area in the image into the specific function is higher than a threshold value.

Furthermore, the concealment degree calculation part 122 may recognize the face of the subject included in the image acquired by the image acquisition part 121, and may calculate the reliability of the facial recognition. In this case, the concealment degree determination part 123 may determine whether the reliability of the facial recognition calculated by the concealment degree calculation part 122 is higher than a threshold value. When the reliability of the facial recognition is higher than a threshold value, the output part 124 may output the alert information.

When the face of the person who is the subject becomes clearer, the reliability of the facial recognition improves. When the reliability of the facial recognition increases, the concealment degree of the image (degree of confidentiality or degree of blur) also declines. That is, the reliability of the facial recognition affects the concealment degree of the image. Therefore, the concealment degree determination part 123 can determine whether the concealment degree is equal to or less than a threshold value by determining whether the reliability of the facial recognition is higher than a threshold value.

In the present first embodiment, the image storage part 14 stores the image acquired by the image capturing part 11, but the present disclosure is not particularly limited to this example. The communication part 15 may transmit the image acquired by the image capturing part 11 to the server 2 (external device) connected via a network, and the server 2 may store the image acquired by the image capturing part 11. In this case, the image deletion part 126 may generate a deletion instruction signal to delete the image stored in the server 2. When the concealment degree is equal to or less than a threshold value, the communication part 15 may transmit the deletion instruction signal to delete the image stored in the server 2 (external device) to the server 2 (external device). Upon receipt of the deletion instruction signal, the server 2 may delete the image stored.

In the present first embodiment, the control part 12 includes the image capturing control part 125 that outputs the image capturing stop signal to stop image capturing to the image capturing part 11 when the concealment degree is equal to or less than a threshold value, but the present disclosure is not particularly limited to this example, and the control part 12 does not have to include the image capturing control part 125.

In the present first embodiment, the control part 12 includes the image deletion part 126 that deletes the image stored in the image storage part 14 when the concealment degree is equal to or less than a threshold value, but the present disclosure is not particularly limited to this example, and the control part 12 does not have to include the image deletion part 126. The image with lower concealment degree can be used for maintenance. Therefore, the image with lower concealment degree may be left without deletion.

In the present first embodiment, the image capturing terminal 1 includes the communication part 15 that transmits the alert information output from the output part 124 to the server 2 and the manager terminal 3 connected via a network, but the present disclosure is not particularly limited to this example, and the image capturing terminal 1 does not have to include the communication part 15. That is, the image capturing terminal 1 does not have to transmit the alert information to the server 2 and the manager terminal 3. The image capturing terminal 1 may transmit the alert information to either the server 2 or the manager terminal 3.

In the present first embodiment, the image capturing terminal 1 includes the image capturing part 11, but the present disclosure is not particularly limited to this example. The image capturing terminal 1 does not have to include the image capturing part 11 therein, and may include an input terminal to which image data is input from an external image capturing device. This allows the image capturing terminal 1 to acquire images from the already installed image capturing device.

In the present first embodiment, the image capturing terminal 1 includes the display part 13, but the present disclosure is not particularly limited to this example. The image capturing terminal 1 does not have to include the display part 13 therein, and may include an output terminal to output the alert information to an external display device. The output part 124 may output the alert information to the external display device (notification device). Upon acquisition of the alert information, the display device (notification device) may notify the person who is the subject of the image capturing part 11 that the concealment degree is declining. This allows the image capturing terminal 1 to output the alert information to the already installed display device.

### Second Embodiment

In the first embodiment, the image capturing terminal 1 calculates the concealment degree, determines the concealment degree, and output the alert information. In contrast, in the second embodiment, a server connected to an image capturing terminal via a network calculates the concealment degree, determines the concealment degree, and outputs the alert information.

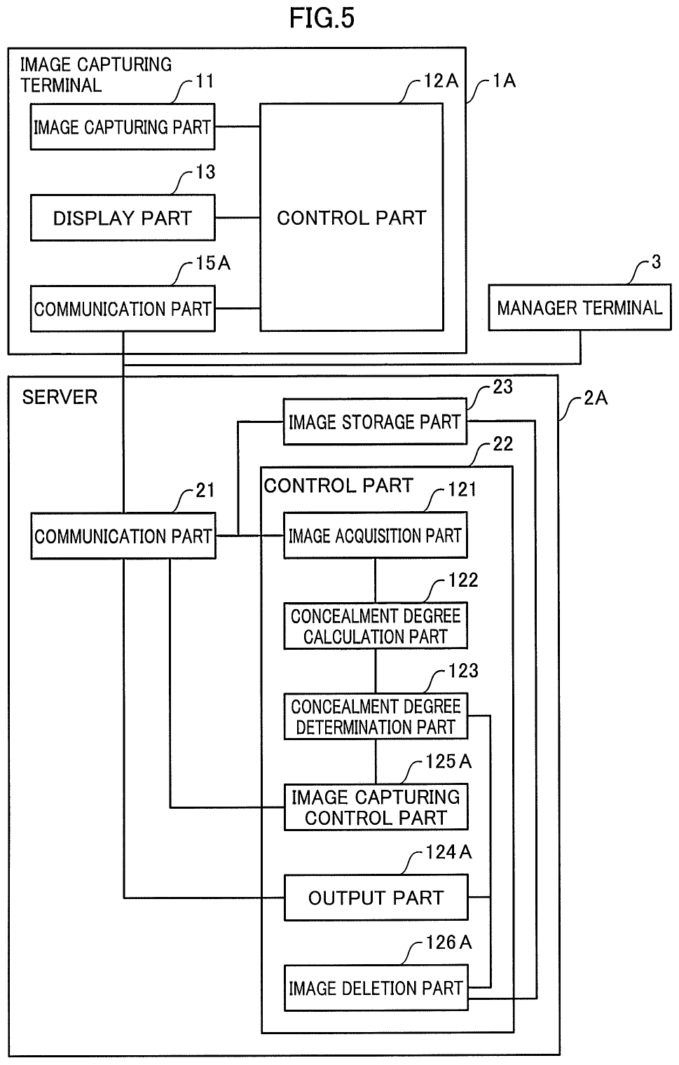

FIG. 5 is a block diagram showing one example of a configuration of an image capturing system in the second embodiment of the present disclosure. The image capturing system includes an image capturing terminal 1A, a server 2A, and a manager terminal 3. Note that in the present second embodiment, the same constituent element as those in the first embodiment will be denoted with the same reference sign, and description thereof will be omitted.

The image capturing terminal 1A is installed in a house, store, or facility. The image capturing terminal 1A includes an image capturing part 11, a control part 12A, a display part 13, and a communication part 15A.

The control part 12A outputs an image obtained through image capturing by the image capturing part 11 to the communication part 15A. The communication part 15A transmits the image obtained through image capturing by the image capturing part 11 to the server 2A.

The communication part 15A receives alert information transmitted by the server 2A. The control part 12A outputs the alert information received by the communication part 15A to the display part 13.

The communication part 15A receives an image capturing stop signal transmitted by the server 2A. The control part 12A outputs the image capturing stop signal received by the communication part 15A to the image capturing part 11.

The server 2A includes a communication part 21, a control part 22, and an image storage part 23.

The communication part 21 receives the image transmitted by the image capturing terminal 1A. The communication part 21 outputs the received image to the control part 22 and the image storage part 23.

The image storage part 23 is implemented by a memory. The memory is, for example, a storage device that can store various types of information, such as a RAM, an HDD, an SSD, or a flash memory. The image storage part 23 stores the image obtained through image capturing by the image capturing part 11 and received by the communication part 21.

The control part 22 is implemented by a microprocessor. The control part 22 includes an image acquisition part 121, a concealment degree calculation part 122, a concealment degree determination part 123, an output part 124A, an image capturing control part 125A, and an image deletion part 126A.

The image acquisition part 121 acquires the image obtained through image capturing by the image capturing part 11 and received by the communication part 21.

When the concealment degree is equal to or less than a threshold value, the output part 124A outputs the alert information for notifying that the concealment degree is declining to the communication part 21. That is, when the concealment degree determination part 123 determines that the concealment degree is equal to or less than a threshold value, the output part 124A outputs the alert information to the communication part 21. When the number of valid pinholes is equal to or less than a threshold value, the output part 124A outputs the alert information to the communication part 21.

When the concealment degree is equal to or less than a threshold value, the image capturing control part 125A outputs the image capturing stop signal for stopping the image capturing to the communication part 21.

The communication part 21 transmits the alert information output from the output part 124A to the image capturing terminal 1A and the manager terminal 3 connected via a network. The communication part 21 transmits the image capturing stop signal output from the image capturing control part 125A to the image capturing terminal 1A.

When the concealment degree is equal to or less than a threshold value, the image deletion part 126A deletes the image stored in the image storage part 23. At this time, the image deletion part 126A deletes images stored in the image storage part 23 from the present time until a predetermined time before. Note that the method for deleting images by the image deletion part 126A is the same as the method for deleting images by the image deletion part 126 of the first embodiment.

Note that in the present second embodiment, the server 2A includes the image storage part 23, but the present disclosure is not particularly limited to this example, and the image capturing terminal 1A may include the image storage part 14. In this case, the image deletion part 126A may generate a deletion instruction signal to delete the image stored in the image capturing terminal 1A. When the concealment degree is equal to or less than a threshold value, the communication part 21 may transmit the deletion instruction signal to delete the image stored in the image capturing terminal 1A to the image capturing terminal 1A. Upon receipt of the deletion instruction signal, the control part 12A of the image capturing terminal 1A may delete the image stored.

Note that in each of the embodiments, each constituent element may include dedicated hardware or may be implemented by execution of a software program suitable for each constituent element. Each constituent element may be implemented by a program execution unit, such as a central processing unit (CPU) or a processor, reading and executing a software program recorded in a recording medium such as a hard disk or a semiconductor memory. The program may be executed by another independent computer system by being recorded in a recording medium and transferred or by being transferred via a network.

Some or all functions of the devices according to the embodiments of the present disclosure are implemented as large scale integration (LSI), which is typically an integrated circuit. These functions may be individually integrated into one chip, or may be integrated into one chip so as to include some or all functions. Circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the devices according to the embodiments of the present disclosure may be implemented by a processor such as a CPU executing a program.

The numerical figures used above are all illustrated to specifically describe the present disclosure, and the present disclosure is not limited to the illustrated numerical figures.

The order in which each step illustrated in the above flowcharts is performed is for specifically describing the present disclosure, and may be an order other than the above order as long as a similar effect can be obtained. Some of the above steps may be executed simultaneously (in parallel) with other steps.

The technology according to the present disclosure is useful as a technology to collect images with confidentiality because, when the concealment degree of the image obtained through image capturing by the image capturing device declines, the privacy of the subject can be protected.

1. An information processing device comprising:
an acquisition part that acquires an image obtained through image capturing by an image capturing device;
a concealment degree calculation part that calculates a concealment degree of the image; and
an output part that outputs alert information to notify that the concealment degree is declining when the concealment degree is equal to or less than a threshold value.

2. The information processing device according to claim 1, wherein
the image capturing device obtains a blurred image by an optical action.

3. The information processing device according to claim 2, wherein
the image capturing device includes an image capturing element and a mask having a plurality of pinholes arranged to cover a light receiving surface of the image capturing element.

4. The information processing device according to claim 3, wherein
the concealment degree calculation part calculates a number of valid pinholes among the plurality of pinholes based on the image, and
when the number of valid pinholes is equal to or less than a threshold value, the output part outputs the alert information.

5. The information processing device according to claim 1, wherein
the concealment degree calculation part calculates a frequency characteristic of a predetermined area in the image, and
the output part outputs the alert information when power of a specific frequency out of the frequency characteristic is higher than a threshold value, when a maximum value of power in a specific frequency area out of the frequency characteristic is higher than a threshold value, when a minimum value of average power in the specific frequency area out of the frequency characteristic is higher than a threshold value, or when a calculated value obtained by inputting a value of the specific frequency area out of the frequency characteristic into a specific function is higher than a threshold value.

6. The information processing device according to claim 1, wherein
the concealment degree calculation part recognizes a face of a subject included in the image and calculates reliability of the facial recognition, and
the output part outputs the alert information when the reliability of the facial recognition is higher than a threshold value.

7. The information processing device according to claim 1, further comprising an image capturing control part that outputs an image capturing stop signal to stop the image capturing to the image capturing device when the concealment degree is equal to or less than a threshold value.

8. The information processing device according to claim 1, further comprising a communication part that transmits the alert information output from the output part to an external device connected via a network.

9. The information processing device according to claim 1, further comprising a notification part that, upon acquisition of the alert information output from the output part, notifies a person who is a subject of the image capturing device that the concealment degree is declining.

10. The information processing device according to claim 1, wherein
the output part outputs the alert information to a notification device, and
upon acquisition of the alert information, the notification device notifies a person who is a subject of the image capturing device that the concealment degree is declining.

11. The information processing device according to claim 1, further comprising:
an image storage part that stores the image; and
an image deletion part that deletes the image stored in the image storage part when the concealment degree is equal to or less than a threshold value.

12. The information processing device according to claim 1, further comprising a communication part that transmits the image to an external device connected via a network to store the image, the communication part transmitting a deletion instruction signal to delete the image stored in the external device to the external device when the concealment degree is equal to or less than a threshold value.

13. An information processing system comprising:
an image capturing device; and
the information processing device according to claim 1.

14. An information processing method comprising, by a computer:
acquiring an image obtained through image capturing by an image capturing device;
calculating a concealment degree of the image; and
outputting alert information to notify that the concealment degree is declining when the concealment degree is equal to or less than a threshold value.
